(19) United States
(12) Patent Application Publication
(10) Pub. No.: US 2025/0259460 A1
(43) Pub. Date: Aug. 14, 2025

(54) SYSTEMS AND METHODS FOR IDENTIFYING GROUPINGS OF CELLS

(71) Applicants: Life Technologies Corporation, Carlsbad, CA (US); INVITROGEN BIOSERVICES INDIA PRIVATE LIMITED, Whitefield (IN)

(72) Inventors: Larry Rystrom, Carlsbad, CA (US); Kim Ippolito, Carlsbad, CA (US); Nicolas Rognin, Carlsbad, CA (US); Pradeep K Y, Bengaluru (IN); Naga Harshini KATIKI, Bengaluru (IN); Mary Kristina Hamilton, Carlsbad, CA (US); Austin Kearns, Eugene, OR (US)

(21) Appl. No.: 19/046,295

(22) Filed: Feb. 5, 2025

Related U.S. Application Data
(60) Provisional application No. 63/551,848, filed on Feb. 9, 2024.

(51) Int. Cl. G06V 20/69; G06V 10/28; G06V 10/34

(52) U.S. Cl. CPC G06V 20/698; G06V 10/28; G06V 10/34; G06V 20/695

(57) ABSTRACT

Systems and methods for identifying clumps (or groupings) of cells in cell counting systems. One example method executed by an electronic processing device for an image processing system includes receiving an image, captured by an imaging device, of a sample having a plurality of cells. The image includes labeling data for each of the plurality of cells. The method includes applying filters, determined based on the labeling data, to the image, processing the image to identify a plurality of groupings of the plurality of cells, and fitting an ellipse around each of the groupings by determining ellipse data for each of the ellipses. Each respective grouping of the plurality of groupings includes at least two cells having a same viability whose cell membranes are touching at least one other cell in the respective grouping.

### RELATED APPLICATIONS

This application claims priority to U.S. Provisional Application No. 63/551,848 filed Feb. 9, 2024, the entire content of which is incorporated by reference herein.

### FIELD

This disclosure generally relates to cell counting systems. More specifically, the present disclosure relates to identifying clumps (or groupings) of cells in cell counting systems.

### BACKGROUND

Cytometry is the counting of cells and/or the measurement of cell characteristics. Various devices and methods are used in the field of cytometry to measure characteristics, such as, for example, cell count, cell size, cell morphology, and cell lifecycle phase. Cytometry may also involve measuring various cellular components, such as, for example, nucleic acids, the presence of specific proteins, cell typing and/or differentiation (e.g., viability counting), and various medical diagnostic applications.

### SUMMARY

Systems and methods described herein generally relate to identifying groupings of cells. For example, some embodiments include organizing detected cells into groupings based on both spatial proximity and the probability of participation in a grouping. In some examples, the provided cell grouping data provides information for studying, for example, cell growth and organization based on, for example, the shape and size distribution of groupings of cells. For example, detection and estimation of cell grouping size and grouping counts can be used to study the effects of certain treatments and treatment concentrations on cell organization, which may provide a measure of effectiveness.

One example method executed by an electronic processing device for an image processing system includes receiving an image, captured by an imaging device, of a sample having a plurality of cells. The image includes labeling data for each of the plurality of cells. The method includes applying filters, determined based on the labeling data, to the image, processing the image to identify a plurality of groupings of the plurality of cells, and fitting an ellipse around each of the groupings by determining ellipse data for each of the ellipses. Each respective grouping of the plurality of groupings includes at least two cells having a same viability whose cell membranes are touching at least one other cell in the respective grouping.

An example of cell viability counting system similarly includes an electronic processor configured to receive an image, captured by an imaging device, of a sample having a plurality of cells. The image includes labeling data for each of the plurality of cells. The electronic processor is configured to apply filters, determined based on the labeling data, to the image, process the image to identify a plurality of groupings of the plurality of cells, and fit an ellipse around each of the groupings by determining ellipse data for each of the ellipses. Each respective grouping of the plurality of groupings includes at least two cells having a same viability whose cell membranes are touching at least one other cell in the respective grouping.

Another example method, executed by an electronic processing device, for an image processing system includes receiving an image, captured by an imaging device, of a sample having a plurality of cells, receiving cell boundary information for the image, and generating a binary mask of the image based on the cell boundary information. The method also includes running a connected component analysis on the mask to detect connected components, generating cell aggregate data based on the image and the detected connected components, and providing the cell aggregate data via a display.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations disclosed herein. These and other features of the present disclosure will become more fully apparent from the following description and appended claims or may be learned by the practice of the disclosure as set forth hereinafter.

### BRIEF DESCRIPTION OF THE DRAWINGS

Features and advantages of the present technology will become more apparent from the following detailed description of example embodiments thereof taken in conjunction with the accompanying drawings in which:

FIG. 1 illustrates a perspective view of an imaging system for cell counting, in accordance with one or more embodiments of the present disclosure.

FIG. 2 is a flow chart of an example cell counting method performed by the imaging system of FIG. 1, in accordance with one or more embodiments of the present disclosure.

FIG. 3 illustrates a schematic of example components within the imaging system of FIG. 1, in accordance with one or more embodiments of the present disclosure.

FIGS. 4A-4C depict various stages of an example image taken of a sample as the image is processed by the imaging system of FIG. 1, in accordance with one or more embodiments of the present disclosure.

FIG. 5 is flowchart of a method for identifying groupings of cells labeled in an image based on both spatial proximity and the probability of a cell participating in a grouping performed by the imaging system of FIG. 1, in accordance with one or more embodiments of the present disclosure.

FIG. 6 is a flowchart of a method for identifying metrics on labelled cells within an input image performed by the imaging system of FIG. 1, in accordance with one or more embodiments of the present disclosure.

FIG. 7 depicts an example labeled image showing live cells and dead cells, in accordance with one or more embodiments of the present disclosure.

FIG. 8 depicts an example labeled image showing detected connected components, in accordance with one or more embodiments of the present disclosure.

FIG. 9 illustrates an example user interface providing an image and cell aggregate data, in accordance with one or more embodiments of the present disclosure.

While the present technology is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Unless otherwise defined, all technical and scientific terms used herein have the same meaning as commonly understood by one of ordinary skill in the art. In case of conflict, the present document, including definitions, will control. Example methods and systems are described below, although methods and systems similar or equivalent to those described herein can be used in practice or testing of the present disclosure. All publications, patent applications, patents and other references mentioned herein are incorporated by reference in their entirety. The systems, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

In addition, unless otherwise indicated, numbers expressing quantities, constituents, distances, or other measurements used in the specification and claims are to be understood as being modified by the term “about.” The terms “about,” “approximately,” “substantially,” or their equivalents, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

The present disclosure is described with reference to the drawings, where like reference numerals are used to refer to like elements throughout. In the following description, for purposes of explanation, numbers of specific details are set forth in order to provide an improved understanding of the present disclosure. It may be evident, however, that the systems and methods of the present disclosure may be practiced without one or more of these specific details. In other instances, well-known structures and devices are shown in block diagram form to facilitate describing the systems and methods of the present disclosure. There is no specific requirement that a system, method, or technique relating to microscope image analysis include all of the details characterized herein to obtain some benefit according to the present disclosure. Thus, the specific examples characterized herein are meant to be example applications of the techniques described and alternatives are possible.

In some embodiments, the described cell grouping identification systems and methods identify groupings of detected cells based on both spatial proximity and the probability of a cell participating in a grouping. In some cases, cells within a grouping are touching. For example, in a grouping, a portion of each cell membrane is touching another cell membrane. Groupings of cells includes a clump of cells (e.g., three or more cells) or a doublet (e.g., two cells).

In some embodiments, the systems and methods receive an image with labeled pixels. For example, one or more masks, such as binary masks, may indicate whether a pixel is associated with an object within the image, such as a cell. In some examples, each labeled pixel represents the identification of a particular detected cell. In some embodiments, the systems and methods process the labeled image to identify groupings of cells. In some cases, the identified groupings are provided for further processing. For example, the cell grouping data can be employed to study cell growth and organization based on the shape and size distribution of the groupings of cells. The cell grouping data may also be used to study the effects of certain treatments and treatment concentrations on cell organization (e.g., by providing a measure of the effectiveness of a treatment).

Accordingly, the systems and methods disclosed herein, which are generic and applicable to any data, employ a process where pre-filters are applied to the received labeled images to improve the identification of touching cells and an enclosing ellipse is fitted to each identified grouping of cells. Moreover, the systems and methods described herein may relate to the international patent application PCT/US2021/055008 (Rognin et al., 2021) dated Oct. 14, 2021, describing an imaging flow cytometry (IFC) data processing method for calculating image parameters, the entire content of which is incorporated by reference herein.

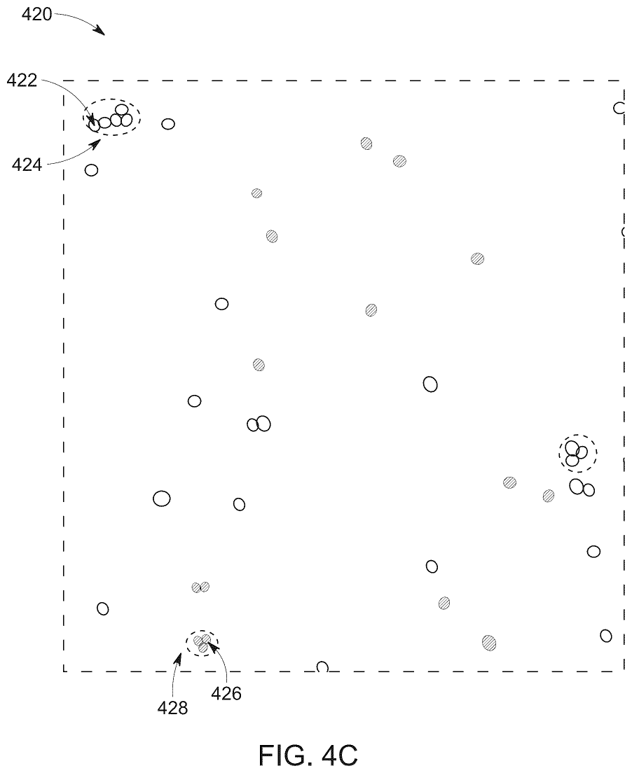

Additional details for this process are provided below in the description of FIG. 5. In one part of the process, after a labeled image is received, a histogram of the foreground pixels of the image and a histogram of the background pixels of the image are computed. In some cases, the foreground includes the parts of the labeled image occupied by cells (e.g., live or dead) while the background includes the non-cell parts of the labeled image. Both histograms are then normalized into empirical probability density functions for the number of pixels as compared to the pixel intensity. A morphology operation is applied to erode the image. For pixels that change value as part of the erosion, a second check is performed to determine the likelihood that the pixel is a part of the foreground.

In a subsequent part of the process, an equivalence table dictionary is created. The dictionary maps a foreground label to a list of equivalent labels. The filtered live-cell and dead-cell label image is traversed and connections between two cells having the same viability, dead or alive, in the equivalence table dictionary are recorded. Connected components are extracted from the dictionary and each connected component is recorded as a grouping of cells. An enclosing ellipse is then fitted to each grouping of cells (e.g., each clump of cells and each doublet of cells). In some embodiments, the system provides a total number (a count) of all cells in a labelled image and a percentage of cells that are identified as belonging to a grouping.

In an example embodiment, a method executed by an electronic processing device for an image processing system includes receiving an image, captured by an imaging device, of a sample having a plurality of cells. The image includes labeling data for each of the plurality of cells. The method includes applying filters, determined based on the labeling data, to the image, processing the image to identify a plurality of groupings of the plurality of cells, and fitting an ellipse around each of the groupings by determining ellipse data for each of the ellipses. Each respective grouping of the plurality of groupings includes at least two cells having a same viability whose cell membranes are touching at least one other cell in the respective grouping.

In another example embodiment, a cell viability counting system includes an electronic processor configured to receive an image, captured by an imaging device, of a sample having a plurality of cells. The image includes labeling data for each of the plurality of cells. The electronic processor is configured to apply filters, determined based on the labeling data, to the image, process the image to identify a plurality of groupings of the plurality of cells, and fit an ellipse around each of the groupings by determining ellipse data for each of the ellipses. Each respective grouping of the plurality of groupings includes at least two cells having a same viability whose cell membranes are touching at least one other cell in the respective grouping.

In another example embodiment, a method, executed by an electronic processing device, for an image processing system includes receiving an image, captured by an imaging device, of a sample having a plurality of cells, receiving cell boundary information for the image, and generating a binary mask of the image based on the cell boundary information. The method also includes running a connected component analysis on the binary mask to detect connected components, generating cell aggregate data based on the image and the detected connected components, and providing the cell aggregate data via a display.

### Example Imaging System

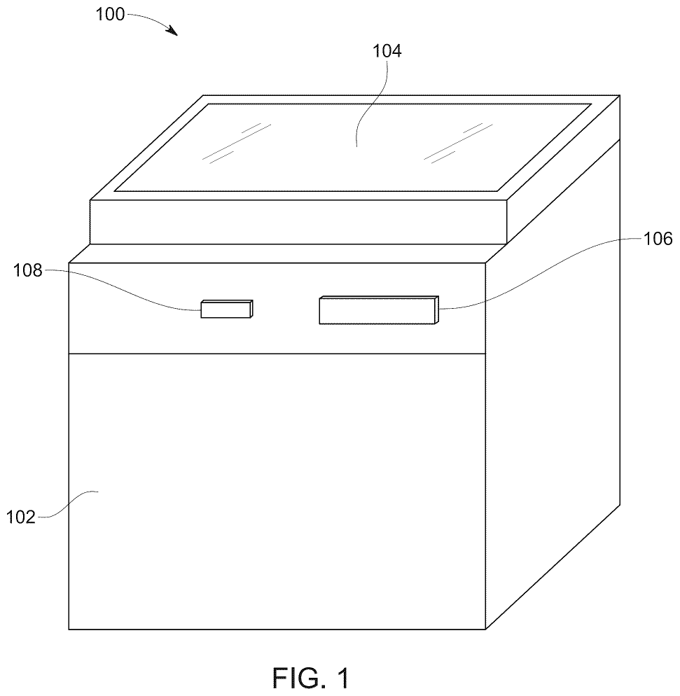

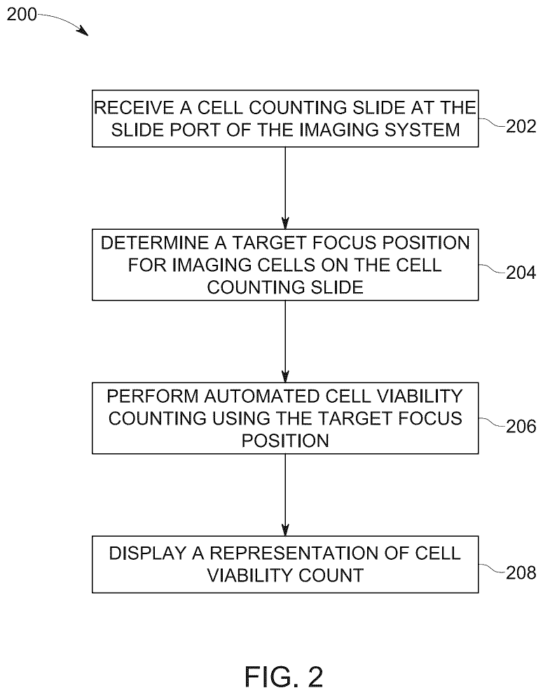

FIG. 1 illustrates a perspective view of an imaging system 100 configured to perform one or more of the methods disclosed herein. For example, the imaging system 100 of FIG. 1 is operable to facilitate the method associated with flow diagram 200 of a cell viability count operation disclosed by the example flow diagram of FIG. 2. As shown, the imaging system 100 includes a housing 102, which encloses and protects the microscope and computing systems used for autofocusing and conducting cell viability counts. The housing 102 includes a slide/port stage assembly 106 operable to receive a cell counting slide into the imaging system (at block 202). Once received therein, the imaging system 100 then determines a target focus position for imaging cells on the cell counting slide (at block 204) and performs automated cell viability counting using the target focus position (at block 206). A representation of the cell viability count is displayed (at block 208) at the imaging system 100 using, for example, display 104. This representation and/or other data associated with the automated cell viability count can be removed from the imaging system 100 and/or saved to a separate device through user interaction with the communications module 108, which in some embodiments can include a USB port or other data exchange port known in the art.

One will appreciate, in view of the present disclosure, that the principles described herein may be implemented utilizing any suitable imaging system and/or any suitable imaging modality. The specific examples of imaging systems and imaging modalities discussed herein are provided by way of example and as a means of describing the features of the disclosed embodiments. Thus, the embodiments disclosed herein are not limited to any particular microscopy system or microscopy application and may be implemented in various contexts, such as brightfield imaging, fluorescence microscopy, flow cytometry, confocal imaging (e.g., 3D confocal imaging, or any type of 3D imaging), and/or others. For example, principles discussed herein may be implemented with flow cytometry systems to provide or improve cell counting capabilities. As another example, cell count and/or viability data obtained in accordance with techniques of the present disclosure may be used to supplement fluorescence data to improve accuracy in distinguishing among different cells.

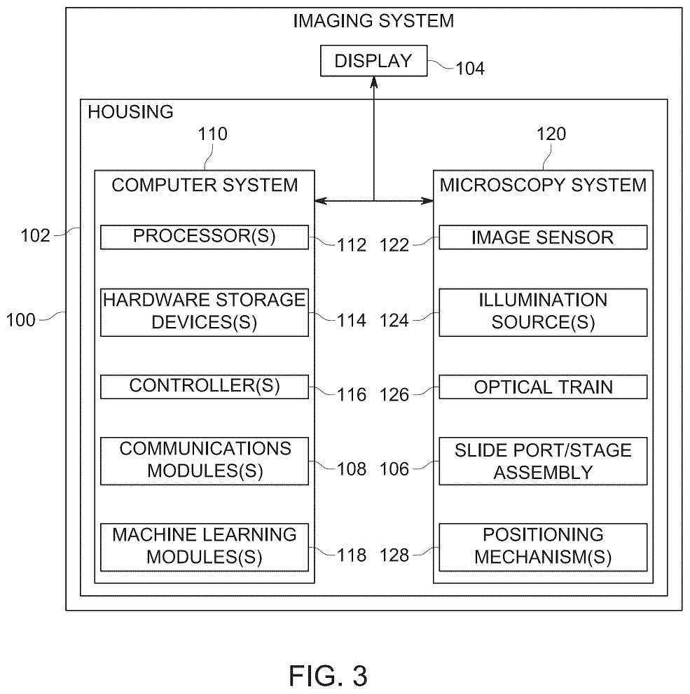

FIG. 3 illustrates a schematic of various example components within the imaging system of FIG. 1, in accordance with one or more embodiments of the present disclosure. For example, FIG. 3 illustrates that the imaging system 100 may include a computer system 110 and a microscopy system 120 included therewith. FIG. 3 conceptually represents the computer system 110 and the microscopy system 120 as disposed within the housing 102 of the imaging system 100. However, one will appreciate, in view of the present disclosure, that any portion of the computer system 110 or the microscopy system 120 may be disposed at least partially outside the housing 102 within the scope of the disclosed embodiments.

FIG. 3 shows that the computer system 110 of the imaging system 100 can comprise various components, such as processor(s) 112 (e.g., electronic processors), hardware storage device(s) 114, controller(s) 116, communications module(s) 108, and/or machine learning module(s) 118.

The processor(s) 112 may comprise one or more sets of electronic circuitry that include any number of logic units, registers, and/or control units to facilitate the execution of computer-readable instructions (e.g., instructions that form a computer program). Such computer-readable instructions may be stored within the hardware storage device(s) 114, which may comprise physical system memory and which may be volatile, non-volatile, or some combination thereof. Additional details related to processors (e.g., processor(s) 112) and computer storage media (e.g., hardware storage device(s) 114) will be provided hereinafter.

The controller(s) 116 may comprise any suitable software components (e.g., set of computer-executable instructions) and/or hardware components (e.g., an application-specific integrated circuit, or other special-purpose hardware component(s)) operable to control one or more physical apparatuses of the imaging system 100, such as portions of the microscopy system 120 (e.g., the positioning mechanism(s) 128).

The communications module(s) 108 may comprise any combination of software or hardware components that are operable to facilitate communication between on-system components/devices and/or with off-system components/devices. For example, the communications module(s) 108 may comprise ports, buses, or other physical connection apparatuses for communicating with other devices (e.g., USB port, SD card reader, and/or other apparatus). Additionally, or alternatively, the communications module(s) 108 may comprise systems operable to communicate wirelessly with external systems and/or devices through any suitable communication channel(s), such as, by way of non-limiting examples, Bluetooth, ultra-wideband, WLAN, infrared communications, and/or others.

The machine learning module(s) 118 may also comprise any combination of software or hardware components that are operable to facilitate processing using machine learning models or other artificial intelligence-based structures/architectures. For example, machine learning module(s) 118 may comprise hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As shown in FIG. 3, the imaging system 100 includes a microscopy system 120 having an image sensor 122, an illumination source 124, an optical train 126, the slide port/stage assembly 106 for receiving the sample slide, and a positioning mechanism 128.

The image sensor 122 is positioned in the optical path of the microscopy system and configured to capture images of the samples, which will be used in the disclosed methods for performing cell counting and for identifying groupings of cells. As used herein, the term “image sensor” or “camera” refers to any applicable image sensor compatible with the apparatuses, systems and methods described herein, including but not limited to charge-coupled devices, complementary metal-oxide-semiconductor devices, N-type metal-oxide-semiconductor devices, Quanta Image Sensors, combinations of the foregoing such as scientific complementary metal-oxide-semiconductor devices, and the like.

The optical train 126 may include one or more optical elements configured to facilitate viewing of the cell counting slide by directing light from the illumination source 124 toward the received cell counting slide. The optical train 126 may also be configured to direct light scattered, reflected, and/or emitted by a specimen within the cell counting slide toward the image sensor 122. The illumination source 124 may be configured to emit various types of light, such as white light or light of one or more particular wavelength bands. For example, the illumination source 124 can include a light cube (e.g., Thermo Fisher EVOS™ light cubes), which may be installed and/or exchanged within the housing to any of a desired set of illumination wavelengths.

The positioning mechanism 128 can include any of an x-axis motor, a y-axis motor, and a z-axis motor that are operable to adjust the components of the optical train 126 and/or image sensor 122 accordingly.

FIG. 3 furthermore illustrates that, in some instances, the imaging system 100 includes a display 104. FIG. 3 indicates that the display 104 may be in communication, whether directly or indirectly, with various other components of the imaging system 100, such as the computer system 110 or the microscopy system 120 thereof (e.g., as indicated in FIG. 3 by the tri-headed arrow). For example, the imaging system 100 may capture images using components of the microscopy system 120, and captured images may be processed and/or stored using components of the computer system 110 (e.g., processor(s) 112, hardware storage device(s) 114, machine learning module(s) 118, etc.), and the processed and/or stored images may be displayed on the display 104 for observation by one or more users.

As described herein, the components of the imaging system 100 may identify groupings of cells labeled in a labeled image. Moreover, one will appreciate, in view of the present disclosure, that an imaging system may comprise additional or alternative components relative to those shown and described with reference to FIG. 1, and that such components may be organized and/or distributed in various manners.

### Example Images

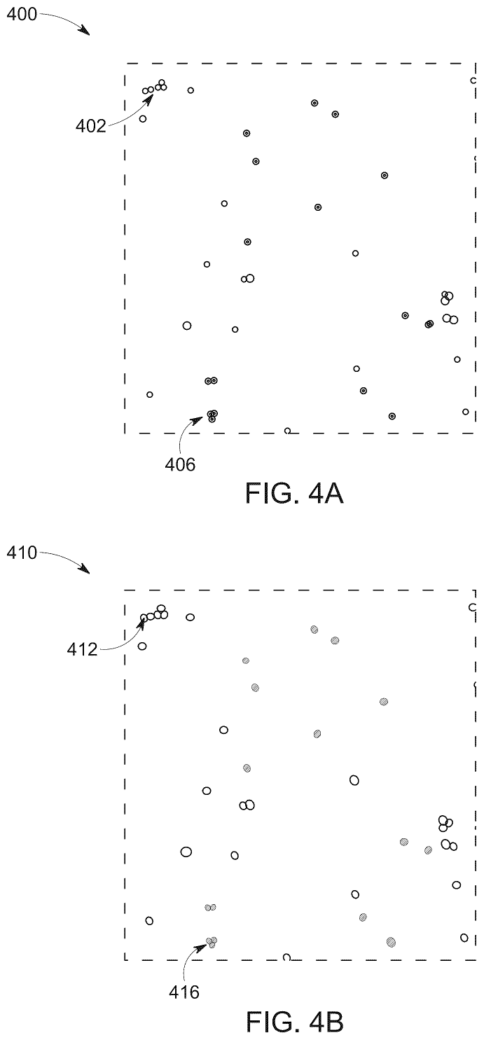

FIGS. 4A-4C depict various stages of an example image taken of a sample as the image is processed by the imaging system 100. For example, the sample may have been loaded into the imaging system 100 (e.g., via the slide port/stage assembly 106). FIG. 4A depicts an example image 400 captured by, for example, the image sensor 122. The foreground of example image 400 includes live cells 402 and dead cells 406 while the background of the example image 400 includes non-cell elements.

In some cases, the example image 400 is processed to the identify cells 402 and 406 and generate the example labeled image 410 depicted in FIG. 4B. For example, image 410 may be generated by processing example image 400 through a model (e.g., the machine learning module(s) 118) trained for classifying pixels while keeping discovered groupings when there are variations (e.g., cell perp, systemic inherent cell variations, and the like). For example, the trained model may identify cells and the viability (e.g., live or dead) of each cell. In the example labeled image 410, the cells highlighted in one color or pattern (e.g., solid white fill for 412) may represent live cells while the cells highlighted in a different color or pattern (e.g., hashed fill for 416) may represent dead cells. In some embodiments, each pixel in the image 410 is labeled (for example, using a binary mask) to indicate whether the pixel is associated with a cell and, in some embodiments, whether the cell is a live cell or dead cell. In some embodiments, the systems and methods described in PCT/US2021/055008 may be used to identify and label cells within an image.

FIG. 4C depicts an example output image 420 of the process 500 described below with reference to FIG. 5 where pre-filters are applied to the label image 410 to improve the identification of touching cells and an enclosing ellipse 424 is fitted to each identified grouping of three or more live cells 422. Another enclosing ellipse 428 is fitted to each identified grouping of three or more dead cells 426. In some embodiments, the enclosing ellipse 424 is fitted to each identified grouping of two or more live cells 422, and enclosing ellipse 428 is fitted to each identified grouping of two or more dead cells 426.

### Example Process

FIG. 5 is a flowchart of an example process 500. The process 500 identifies grouping of cells labeled in an image based on both spatial proximity and the probability of a cell participating in a grouping. For clarity of presentation, the description that follows generally describes the example process 500 in the context of FIGS. 1, 4A, 4B, and 4C and, in particular, is described as being implemented by the components of the imaging system 100 described above with respect to FIG. 1. However, it will be understood that the process 500 may be performed, for example, by any other suitable system, environment, software, and hardware, or a combination of systems, environments, software, and hardware as appropriate. In some embodiments, various operations of the process 500 can be run in parallel, in combination, in loops, or in any order. As depicted, the process 500 includes a pre-filtering part (at 510) that includes applying pre-filters to a received labeled image, which, among other things, identifies touching cells, and an enclosing part (at 530) that includes fitting an enclosing ellipse to each identified grouping of cells. The pre-filtering step generally includes steps 512-518 and the enclosing step generally includes steps 522-528. These steps are described in detail below.

At 502, a labeled image (e.g., example image 410) is received. In some embodiments, the labeled image includes identifying information related to depicted cells. For example, the information may include the location of the dead cells and live cells in the image. In some cases, the labeled image is generated from a raw image (e.g., example image 400) of a collected sample processed through a model trained for pixel labeling. The foreground of the labeled image includes the depicted cells (e.g., live or dead) while the background includes the non-cell parts of the image.

From 502, the process 500 proceeds to step 512 where a histogram of the foreground pixels of the labeled image and a histogram of the background pixels of the labeled image are computed.

From 512, the process 500 proceeds to 514 where the histograms are normalized into empirical probability density functions for a number of pixels as compared to a pixel intensity of the image. For example, the area under the curve of each histogram is normalized according to a value such that the sum of the probability is equal to 1 across all pixels, where f is the likelihood that a pixel is part of the foreground and b is the likelihood, a pixel is part of the background.

From 514, the process 500 proceeds to 516 where a morphology operation is applied to erode the labeled image. In some examples, the operation includes a probability, between zero and one, assigned as a value to each pixel and related to whether the assigned pixel is in the foreground. For example, the labeled image is eroded with the “+” shape structuring element ({{−1,0), (0,−1), (0,0), (1,0), (0,1)}). The structuring element includes a shape used to probe or interact with a given image (e.g., the provided labeled image), with the purpose of drawing conclusions on how this shape fits or misses the shapes in the image.

From 516, the process 500 proceeds to 518 where each of the pixels whose values were changed as part of the erosion are processed to determine a likelihood that the pixel is a part of the foreground. As an example, the following rule may be applied for each of these pixels: if p (pixel)>0.9 then restore the pixel from the effects of the erosion, where p(pixel)=(/(pixel)*0.1)/(f(pixel)*0.1+b(pixel)*0.9) [Bayes Rule with a prior probability of 0.1 that a pixel is part of the foreground]. In such an example, pixels having a probability of more than .9 (90%) are restored. In some cases, the probability threshold may be adjusted according to the specific application or sample. For example, the probability threshold may be lowered to approximately .75 (75%) or raised to approximately .95 (95%). Other threshold probabilities may be used based on the specific parameters of the experiment or sample type.

From 518, the process 500 proceeds to 522 where an equivalence table dictionary is created. In some examples, the dictionary maps a foreground label to a list of equivalent labels. The equivalent table dictionary lists connected labels, where a label is defined by a cell number and cell viability (live or dead). For example, the processing of image in FIG. 4B resulted in 42 cells numbered from 1 to 42 where 26 cells and 16 cells were identified as live and dead, respectively. Given that there are 4 groups of connected live cells (1 group of 5, 1 group of 3, and 2 groups of 2) and 2 groups of connected dead cells (1 group of 3 and 1 group of 2), the equivalence table dictionary contains a total of 16 connected labels: (5+3+2*2)+(3+1)=16.

From 522, the process 500 proceeds to 524 where connections between two cells having the same viability (e.g., dead or alive) in the equivalence table dictionary are recorded. In some examples, connections between cells are determined based on traversing the pixels associated with a cell (according to the equivalence table dictionary) where 4-connected or 8-connected points in two-dimensional (2D) space are recorded. 4-connected points are neighbors to every pixel that touches one of their edges or corners and are connected horizontally and vertically. 8-connected pixels are neighbors to every pixel that touches one of their edges or corners and are connected horizontally, vertically, and diagonally.

From 524, the process 500 proceeds to 526 where connected components are extracted from the equivalence table dictionary and each connected component is recorded as a grouping of cells. As used herein, “connectedness,” as used in “connected components,” refers to which pixels are considered neighbors of a pixel of interest. A connected component is a set of pixels of a single value, for example, the value representing black, wherein a path can be formed from any pixel of the set to any other pixel in the set without leaving the set, for example, by traversing only black pixels. In general terms, a connected component may be either “4-connected” or “8-connected.” In the 4-connected case, the path can move in only horizontal or vertical directions, so there are four possible directions. Accordingly, two diagonally adjacent black pixels are not 4-connected, unless there is another black pixel horizontally or vertically adjacent, serving as a bridge between the two. In the 8-connected case, the path between pixels may also proceed diagonally. One embodiment uses 8-connected components (i.e., connected component analysis is run using 8-connectivity detection), but 4-connected components could also be identified and used.

From 526, the process 500 proceeds to 528 where an enclosing ellipse is fitted to each grouping of cells. In some embodiments, the information for each fitted ellipse includes a center coordinate (e.g., XY coordinate), a radius major (long axis), a radius minor (short axis), an orientation (angle) in degrees, and the viability (live or dead) of the included cells. In some examples, the ellipse information is stored to a file associated with the image, such as, for example, a JSON file.

From 528, the process 500 proceeds to 530 where the labeled image and enclosing ellipses are provided for further processing. In some examples, the labeled image and enclosing ellipses (e.g., example image 420) are provided to the display 104 or a connected user device. In some embodiments, a total number of cells in the label image and a percentage of cells that are identified as belonging to a grouping are provided to the display 104 or a connected user device. In some embodiments, a separate number (count) of the cells in the labeled image that are included in a grouping (e.g., a clump or a doublet), or a singlet (only one cell that is not touching any other cell) respectively are provided to the display 104 or the connected user device. In some examples, a percent aggregate (e.g., 50% aggregation where 50% of the cells are in groupings and 50% are not) is provided to the display 104 or a connected user device. In some embodiments, a number (count) of the number of two-cell groupings (e.g., a doublet), three-cell groupings, four-cell groupings, five-cell groupings, six-cell groupings, and so forth respectively are provided to the display 104 or a connected user device. In some cases, a percentage of these cell counts as compared to the total number of cells may be provided as output. In some examples, information related to each identified groupings (or doublet) is provided to the display 104 or a connected user device such as, for example, the number of cells, cell viability, or related ellipse information.

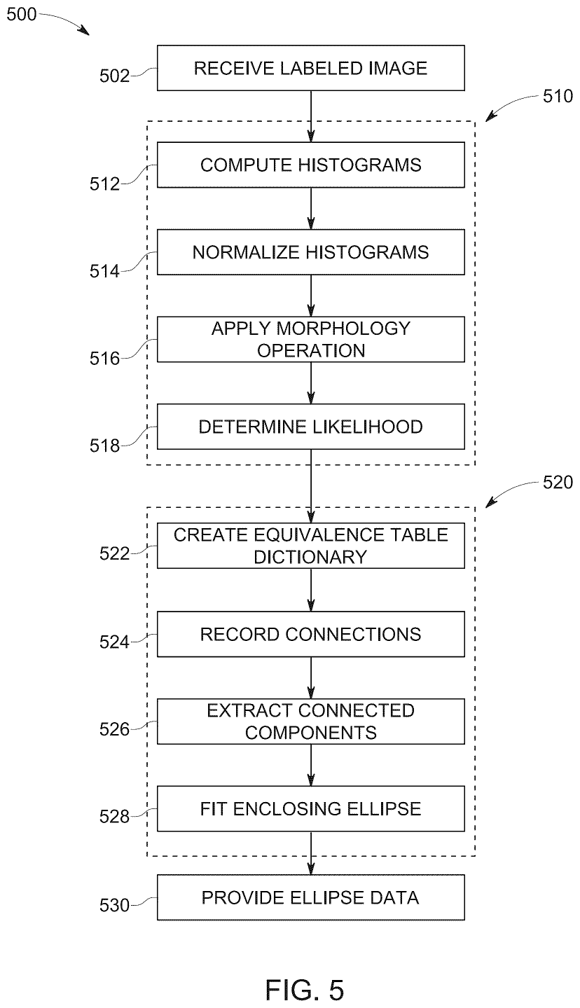

As noted above, identified cells and cell groupings (identified per the methods described herein or other methods) may be used to generate various metrics. FIG. 6 is a flowchart of an example process 600 for generating such metrics. The process 600 identifies metrics on cells within an input image, such as numbers (counts) of live cells, dead cells, a percentage of cells within groupings of cells, or a combination thereof. For clarity of presentation, the description that follows generally describes the example process 600 in the context of FIGS. 1, 7, and 8, and, in particular, is described as being implemented by the components of the imaging system 100 described above with respect to FIG. 1. However, it will be understood that the process 600 may be performed, for example, by any other suitable system, environment, software, and hardware, or a combination of systems, environments, software, and hardware as appropriate. In some embodiments, various operations of the process 600 can be run in parallel, in combination, in loops, or in any order. Also, in some embodiments, one or more portions of the process 500 described herein may be used with the process 600. However, in other embodiments, the process 600 may be performed independent of the process 500.

At 602, an image (e.g., example image 410) is received, wherein the image is of a sample having a plurality of cells. In some embodiments, the received image is a labeled image that includes identifying information related to depicted plurality of cells. For example, the information may include the location of the dead cells and live cells in the image. In some cases, the labeled image is generated from a raw image (e.g., example image 400) of a collected sample processed through a model trained for pixel labeling. The foreground of the labeled image includes the depicted cells (e.g., live or dead) while the background includes the non-cell parts of the image.

In some embodiments, the labeled image is an image representing an example result following processing by an AI-assisted autofocus and automated cell viability count system. The locations and masks of the live and dead cells may be obtained as outputs from an artificial neural network. An example AI-assisted autofocus and automated cell viability count system is described in previously-mentioned international patent application PCT/US2021/055008.

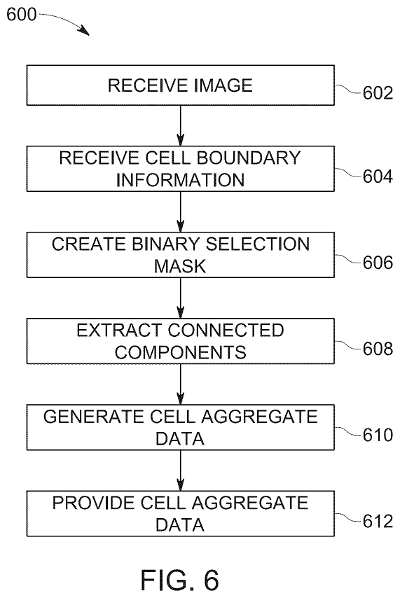

From 602, the process 600 proceeds to step 604 where cell boundary information, such as, for example, ellipse markers or parameters, are received. In some examples, the cell boundary information (e.g., ellipse information) is included as part of the received image (e.g., the labeled image). In other examples, the cell boundary information is obtained from a file associated with the image, such as, for example, a JSON file. For example, the image may be associated with a map showing detected cells, such as, for example, a boundary or ellipse marking each individual cell. For example, as illustrated in FIG. 7, in some embodiments, the map may define markers for cells detected within the image, such as, for example, solid line ellipse markers 702 identifying live cells and dashed line ellipse markers 704 identify dead cells. When overlain on the received image (e.g., a corresponding brightfield image 700 as displayed via, for example, the display 104 of the imaging system 100), the markers 702 and 704 identify live and dead cells within the image. It should be understood that live and dead cells may be visually differentiated in various ways via the markers or other indicia. For example, live cells may be outlined, shaded, and/or otherwise emphasized with a particular color (e.g., green), whereas dead cells may be outlined, shaded, and/or otherwise emphasized with a different color (e.g., red). As the map defines the boundaries of detected cells, the map (the cell boundary information represented therein) represents cell count information for the image (e.g., a number of all cells (the plurality of cells depicted in the image), a number of dead cells, a number of live cells, or a combination thereof). If ellipses are not drawn (overlain) on the image (see, e.g., FIG. 7), ellipses may be drawn on the image as part of step 602. From step 604, the process 600 proceeds to step 606 where a binary mask of the image is created (for example, generated). The binary mask indicates pixels of the labeled image (including the drawn cell boundary markers) representing a cell boundary. Various techniques for generating the binary mask are within the scope of this disclosure, such as, for example, using the boundary markers drawn on the image to generate a binary mask, such that pixels within and/or included in a marker are set to one value (e.g., 1) and all other pixels are set to a different value (e.g., 0). Other information included in the labeled image could similarly be used to apply a binary mask, such as, for example, pixel values. For example, various threshold values may be applied to pixel values to apply a binary mask (e.g., setting pixel values above a predetermined threshold, such as values representing 50% to 90% or greater of a maximum pixel intensity value to one value and setting all other pixels to a different value). Similarly, other information included as part of the labeled image may be used to apply the binary mask and, in general, set each pixel representing a cell boundary to one value (e.g., 1) while setting all other pixel values to a different value (e.g., 0). It should also be understood that, in some embodiments, the mask identifies cell boundaries as well as pixels positioned within the cell boundaries (i.e., representing the cell itself).

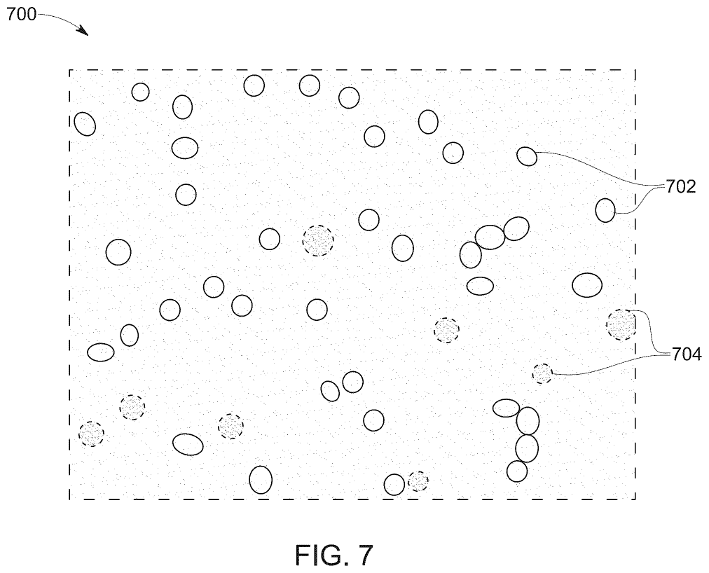

From step 606, the process proceeds to step 608 where connected components are extracted from the binary mask and each connected component is recorded. For example, connected components may be identified as previously described with respect to step 526 of process 500 such as, for example, running a connected component analysis (e.g., 8-connectivity detection) on the binary mask to detect connected cell boundaries. Each connected component detected at step 606 may include one cell boundary (representing a singlet or individual cell) or a plurality of cells with connected boundaries. For example, as illustrated in FIG. 8, the connected component analysis may detect both an individual cell 802 and a grouping of cells 804, wherein each of 802 and 804 are recorded as a connected component and contribute to a total number of detected connected components.

From step 608, the process 600 proceeds to step 610 where cell aggregate data is generated. In particular, as noted above, the labeled image and/or the cell boundary information (e.g., as read from the JSON file) represents a total number (a count) of individual cells detected within the image and the results of the connected component analysis includes a number (count) of connected components. These values can be used (e.g., compared) to determine a metric representing how “clumpy” cells detected in the image are (i.e., quantifying cell aggregation). For example, an aggregate fraction may be calculated using Equation 1:

$$Aggregate Fraction = 1 - ( \frac{CC {A}_{c o u n t}}{Count} ) \qquad ( 1 )$$

### Where:

CCA_{count} is the number of connected components (detected using the connected component analysis run on the image with the binary mask applied); and
Count is the total number of individual cells (i.e., a number (count) of the plurality of cells) depicted in the labeled image (e.g., per the received cell boundary information).

For example, as one non-limiting example, if the cell boundary information (e.g., ellipse information) indicates that 608 individual cells were detected in the image and the connected component analysis identifies 573 connected components, the image may have an aggregate fraction (“clumpy” value) of approximately 17.908310%. It should be understood that the aggregate fraction may be generated as a decimal value, a percentage, or both.

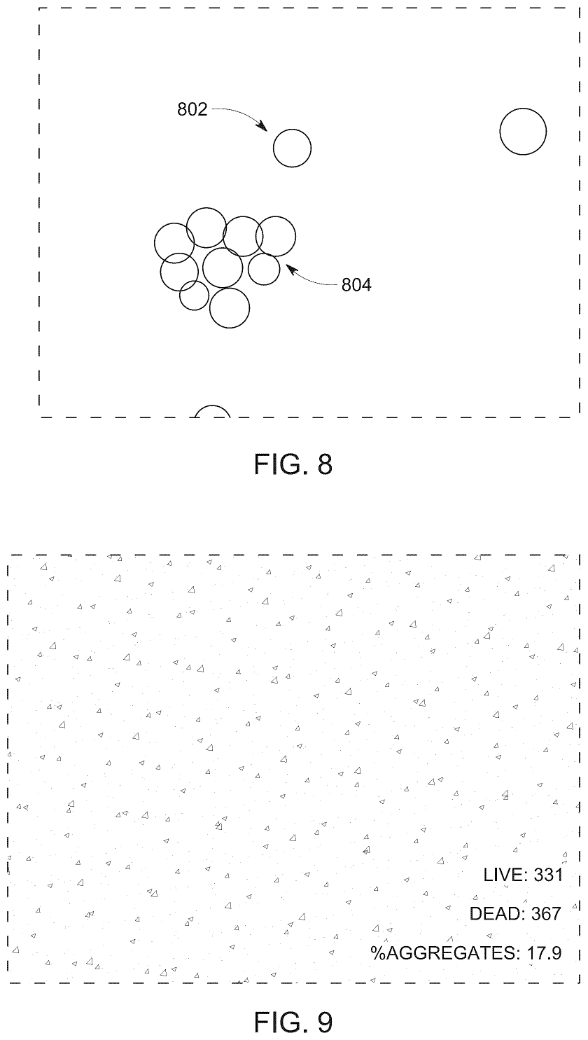

From step 610, the process proceeds to step 612 where the cell aggregate data is provided. In some examples, the image (with or without the drawn ellipse markers) and the associated aggregate data are provided to the display 104 or a connected user device (see, e.g., FIG. 9). However, in other embodiments, the aggregate data may be provided separate from the image. In some embodiments, the aggregate data includes the aggregate fraction representing how “clumpy” the detected cells are (e.g., the higher the fraction, the higher the percentage of cell groupings (clumps) as compared to individual cells). In some embodiments, the aggregate data (e.g., provided via the display 104) also includes cell count information, such as, for example, a number of all cells in the image, a number of live cells in the image, a number of dead cells in the image, or a combination thereof. These numbers may be provided based on the received image (which, as noted above, may be a labeled image), the cell boundary information, or a combination thereof. The cell aggregate data may also include, based on the results of the connected component analysis, a number of detected connected components, a number of detected connected components representing multiple cells (i.e., a clump or cell grouping), a number of detected connected components representing an individual cell (a singlet where the connected component only includes one cell that is not touching any other cell), or a combination thereof. The numbers associated with clumps versus singlets may be determined by analyzing the size, shape, or other properties of each connected component. It should also be understood that the aggregate fraction (and other provided cell aggregate data) may be determined and provided for all cells represented in the image, a particular category of cells represented in the image, or a combination thereof. For example, the aggregate fraction may be determined and provided for all cells represented in the image, live cells represented in the image, dead cells represented in the image, or a combination thereof. For example, as noted above, information provided via the cell boundary information and/or as part of the image itself (as a labeled image) may indicate whether a detected cell was identified as being a live cell or a dead cell and, hence, this information may be used to determine a total number of live cells and/or a total number of dead cells and also to run the connected component analysis on cells included in a particular category.

### Non-transitory Computer Readable Storage Medium

In some embodiments, the platforms, systems, media, and methods disclosed herein include one or more non-transitory computer readable storage media encoded with a program including instructions executable by the operating system of an optionally networked computer (e.g., the imaging system 100). In further embodiments, a computer readable storage medium is a tangible component of a computer. In some embodiments, a computer readable storage medium is optionally removable from a computer. In some embodiments, a computer readable storage medium includes, by way of non-limiting examples, compact disc read-only memories (CD-ROMs), digital versatile discs (DVDs), flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in an electronic processor (e.g., the processor(s) 112) of the computer, written to perform a specified task. Computer readable instructions may be implemented as program modules, such as functions, objects, application programming interface (API), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Data Stores

In some embodiments, the platforms, systems, media, and methods disclosed herein include one or more data stores. Data stores include repositories for persistently storing and managing collections of data. Types of data stores repositories include, for example, databases and simpler store types, or use of the same. Simpler store types include files, emails, and so forth. In some embodiments, a database is a series of bytes that is managed by a database management system (DBMS). In various embodiments, suitable databases include, by way of non-limiting examples, relational databases, non-relational databases, object-oriented databases, object databases, entity-relationship model databases, associative databases, and extensible markup language (XML) databases. Further non-limiting examples include structured query language (SQL), PostgreSQL, MySQL, Oracle, DB2, and Sybase. In some embodiments, a database is cloud computing based.

### Standalone Application

In some embodiments, a computer program includes a standalone application, which is a program that is run as an independent computer process, not an add-on to an existing process, (e.g., not a plug-in). Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable compiled applications.

### Software Modules

In some embodiments, the systems and methods disclosed herein include software, server, or database modules. Software modules are created using machines, software, and languages. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

Furthermore, the modules, processes systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various Figures of and for embodiments above may be distributed across multiple computers or systems or may be co-located in a single processor or system. Example structural embodiment alternatives suitable for implementing the modules, sections, systems, means, or processes described herein are provided below.

The modules, processors, or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

As described above in the detailed description, reference is made to the accompanying drawings that form a part hereof wherein like numerals designate like parts throughout, and in which is shown, by way of illustration, implementations that may be practiced. It is to be understood that other implementations may be utilized, and structured or logical changes may be made, without departing from the scope of the present disclosure. Therefore, the detailed description as described above is not to be taken in a limiting sense.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future (e.g., any elements developed that perform the same function, regardless of structure).

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Various operations may be described as multiple discrete actions or operations in turn, in a manner that is most helpful in understanding the subject matter disclosed herein. However, the order of description should be construed as to imply that these operations are necessarily order dependent. In particular, these operations may not be performed in the order of presentation. Operations described may be performed in a different order from the described implementation. Various additional operations may be performed, and/or described operations may be omitted in additional implementations.

Implementations of the present disclosure are disclosed in the following clauses:

Clause 1. A method, executed by an electronic processing device, for an image processing system, the method comprising: receiving an image, captured by an imaging device, of a sample having a plurality of cells, wherein the image includes labeling data for each of the plurality of cells; applying filters, determined based on the labeling data, to the image; processing the image to identify a plurality of groupings of the plurality of cells, wherein each respective grouping of the plurality of groupings includes at least two cells having a same viability whose cell membranes are touching at least one other cell in the respective grouping; and fitting an ellipse around each of the groupings by determining ellipse data for each of the ellipses.

Clause 2. The method of clause 1, wherein the ellipse data includes a center coordinate, a radius major, a radius minor, and an orientation.

Clause 3. The method of clause 1 or 2, wherein the labeling data include a location and a viability of each of the plurality of cells.

Clause 4. The method of any of clauses 1-3, wherein the plurality of cells is depicted in a foreground of the image.

Clause 5. The method of any of clauses 1-4, wherein applying the filters to the image includes: determining a foreground histogram of foreground pixels in the image and a background histogram of background pixels in the image; normalizing the foreground histogram and the background histogram into an empirical probability density function; and applying a morphology operation to erode the image.

Clause 6. The method of clause 5, wherein the image includes a plurality of pixels, wherein applying the filters to the image further includes: for each respective pixel of the plurality of pixels whose values changed during erosion of the image, determining a likelihood that the respective pixel is a part of a foreground of the image, and restoring each respective pixel based on the respective likelihood satisfying a threshold.

Clause 7. The method of clause 6, wherein the threshold is greater than 90 percent.

Clause 8. The method of any of clauses 1-7, wherein the plurality of groupings of cells are identified by traversing a plurality of pixels in the image associated with each of the plurality of cells to determine connected points in a two-dimensional (2D) space represented in the image.

Clause 9. The method of clause 8, where the connected points are extracted from an equivalence table dictionary to determine connected cells in each of the plurality of groupings.

Clause 10. The method of any of clauses 1-9, further comprising: providing the image and the ellipse data to a display.

Clause 11. The method of any of clauses 1-10, further comprising: determining a total number of the plurality of cells and a percentage of the plurality of cells included in the plurality of groupings.

Clause 12. A cell viability counting system, comprising: an electronic processor configured to: receive an image, captured by an imaging device, of a sample having a plurality of cells, wherein the image includes labeling data for each of the plurality of cells; apply filters, determined based on the labeling data, to the image; process the image to identify a plurality of groupings of the plurality of cells, wherein each respective grouping of the plurality of groupings includes at least two cells having a same viability whose cell membranes are touching at least one other cell in the respective grouping; and fit an ellipse around each of the groupings by determining ellipse data for each of the ellipses.

Clause 13. The cell viability counting system of clause 12, wherein the ellipse data includes a center coordinate, a radius major, a radius minor, and an orientation.

Clause 14. The cell viability counting system of clause 12 or 13, wherein the labeling data include a location and a viability of each of the plurality of cells.

Clause 15. The cell viability counting system of any of clauses 12-14, wherein the plurality of cells is depicted in a foreground of the image.

Clause 16. The cell viability counting system of any of clauses 12-15, wherein to apply the filters to the image, the electronic processor is configured to: determine a foreground histogram of foreground pixels in the image and a background histogram of background pixels in the image; normalize the foreground histogram and the background histogram into an empirical probability density function; and apply a morphology operation to erode the image.

Clause 17. The cell viability counting system of clause 16, wherein the image includes a plurality of pixels, and wherein to apply the filter to the image, the electronic processor is configured to: for each respective pixel of the plurality of pixels whose values changed during erosion of the image, determining a likelihood that the respective pixel is a part of a foreground of the image, and restoring each respective pixel based on the respective likelihood satisfying a threshold.

Clause 18. The cell viability counting system of any of clauses 12-17, wherein the plurality of groupings of cells are identified by traversing a plurality of pixels in the image associated with each of the plurality of cells to determine connected points in a two-dimensional (2D) space represented in the image.

Clause 19. The cell viability counting system of clause 18, where the connected points are extracted from an equivalence table dictionary to determine connected cells in each of the plurality of groupings.

Clause 20. The cell viability counting system of any of clauses 12-19, wherein the electronic processor is configured to: determine a total number of the plurality of cells and a percentage of the plurality of cells included in the plurality of groupings.

Clause 21. A method, executed by an electronic processing device, for an image processing system, the method comprising: receiving an image, captured by an imaging device, of a sample having a plurality of cells; receiving cell boundary information for the image; generating a binary mask of the image based on the cell boundary information; running a connected component analysis on the binary mask to detect connected components; generating cell aggregate data based on the image and the detected connected components; and providing the cell aggregate data via a display.

Clause 22. The method of clause 21, wherein the binary mask sets each pixel in the image to a first value in response to the pixel representing a cell boundary and a second value in response to the pixel not representing a cell boundary.

Clause 23. The method of clause 21 or 22, wherein the connected component analysis performs 8-connectivity detection.

Clause 24. The method of any of clauses 21-23, wherein generating the cell aggregate data includes dividing a number of the detected connected cell boundaries by a number of the plurality of cells.

Clause 25. The method of any of clauses 21-24, wherein the cell of the plurality of cells represents at least one selected from a group consisting of a number of all cells in the image, a number of live cells in the image, and a number of dead cells in the image.

Clause 26. The method of any of clauses 21-25, wherein the aggregate cell data includes at least one selected from a group consisting of an aggregate fraction of all cells in the image, an aggregate fraction of live cells in the image, and an aggregate fraction of dead cells in the image.

What is claimed is:

1. A method, executed by an electronic processing device, for an image processing system, the method comprising:
receiving an image, captured by an imaging device, of a sample having a plurality of cells, wherein the image includes labeling data for each of the plurality of cells;
applying filters, determined based on the labeling data, to the image;
processing the image to identify a plurality of groupings of the plurality of cells, wherein each respective grouping of the plurality of groupings includes at least two cells having a same viability whose cell membranes are touching at least one other cell in the respective grouping; and
fitting an ellipse around each of the groupings by determining ellipse data for each of the ellipses.

2. The method of claim 1, wherein the ellipse data includes a center coordinate, a radius major, a radius minor, and an orientation.

3. The method of claim 1, wherein the labeling data include a location and a viability of each of the plurality of cells.

4. The method of claim 1, wherein the plurality of cells is depicted in a foreground of the image.

5. The method of claim 1, wherein applying the filters to the image includes:
determining a foreground histogram of foreground pixels in the image and a background histogram of background pixels in the image;
normalizing the foreground histogram and the background histogram into an empirical probability density function; and
applying a morphology operation to erode the image.

6. The method of claim 5, wherein the image includes a plurality of pixels, wherein applying the filters to the image further includes:
for each respective pixel of the plurality of pixels whose values changed during erosion of the image, determining a likelihood that the respective pixel is a part of a foreground of the image, and
restoring each respective pixel based on the respective likelihood satisfying a threshold.

7. The method of claim 6, wherein the threshold is greater than 90 percent.

8. The method of claim 1, wherein the plurality of groupings of cells are identified by traversing a plurality of pixels in the image associated with each of the plurality of cells to determine connected points in a two-dimensional (2D) space represented in the image.

9. The method of claim 8, where the connected points are extracted from an equivalence table dictionary to determine connected cells in each of the plurality of groupings.

10. The method of claim 1, further comprising:
providing the image and the ellipse data to a display.

11. The method of claim 1, further comprising:
determining a total number of the plurality of cells and a percentage of the plurality of cells included in the plurality of groupings.

12. A cell viability counting system, comprising:
an electronic processor configured to:
receive an image, captured by an imaging device, of a sample having a plurality of cells, wherein the image includes labeling data for each of the plurality of cells;
apply filters, determined based on the labeling data, to the image;
process the image to identify a plurality of groupings of the plurality of cells, wherein each respective grouping of the plurality of groupings includes at least two cells having a same viability whose cell membranes are touching at least one other cell in the respective grouping; and
fit an ellipse around each of the groupings by determining ellipse data for each of the ellipses.

13. The cell viability counting system of claim 12, wherein to apply the filters to the image, the electronic processor is configured to:
determine a foreground histogram of foreground pixels in the image and a background histogram of background pixels in the image;
normalize the foreground histogram and the background histogram into an empirical probability density function; and
apply a morphology operation to erode the image.

14. The cell viability counting system of claim 13, wherein the image includes a plurality of pixels, and wherein to apply the filter to the image, the electronic processor is configured to:
for each respective pixel of the plurality of pixels whose values changed during erosion of the image, determining a likelihood that the respective pixel is a part of a foreground of the image, and
restoring each respective pixel based on the respective likelihood satisfying a threshold.

15. The cell viability counting system of claim 12, wherein the plurality of groupings of cells are identified by traversing a plurality of pixels in the image associated with each of the plurality of cells to determine connected points in a two-dimensional (2D) space represented in the image.

16. A method, executed by an electronic processing device, for an image processing system, the method comprising:
receiving an image, captured by an imaging device, of a sample having a plurality of cells;
receiving cell boundary information for the image;
generating a binary mask of the image based on the cell boundary information;
running a connected component analysis on the binary mask to detect connected components;
generating cell aggregate data based on the image and the detected connected components; and
providing the cell aggregate data via a display.

17. The method of claim 16, wherein the binary mask sets each pixel in the image to a first value in response to the pixel representing a cell boundary and a second value in response to the pixel not representing a cell boundary.

18. The method of claim 16, wherein the connected component analysis performs 8-connectivity detection.

19. The method of claim 16, wherein the cell of the plurality of cells represents at least one selected from a group consisting of a number of all cells in the image, a number of live cells in the image, and a number of dead cells in the image.

20. The method of claim 16, wherein the aggregate cell data includes at least one selected from a group consisting of an aggregate fraction of all cells in the image, an aggregate fraction of live cells in the image, and an aggregate fraction of dead cells in the image.
